(19) United States
(12) Patent Application Publication
(10) Pub. No.: US 2023/0159403 A1
(43) Pub. Date: May 25, 2023

(54) PROCESS FOR TREATMENT OF SEWAGE SLUDGE AND PRODUCT OF SAME

(71) Applicant: JRV, LLC., Virginia Beach, VA (US)

(72) Inventors: John MORIARTY, Virginia Beach, VA (US); Raymond E. GROVER, Virginia Beach, VA (US); Vernon B. MEACHAM, Blacksburg, VA (US)

(21) Appl. No.: 17/289,318

(22) PCT Filed: Oct. 30, 2019
(86) PCT No.: PCT/US2019/058799

§ 371 Date: Apr. 28, 2021

Related U.S. Application Data
(63) Continuation of application No. 16/175,536, filed on Oct. 30, 2018, now abandoned.

(51) Int. Cl. C05F 7/00; C05G 5/12

(52) U.S. Cl. CPC C05F 7/005; C05G 5/12; C02F 11/18

(57) ABSTRACT

A process of treating sewage sludge and the formation of a granular product thereof, wherein said process comprises utilizing a urea-formaldehyde resin to treat a sludge product from thermal hydrolysis processes (THPs) to create an end product for agricultural and other uses. The process utilizes a high intensity mixing and chopping reactor, which combines the sludge with a resin and utilizes sulfuric or other mineral acid to polymerize the resin. The resultant product is subsequently dried and sized through a screening process. The process results in an end product that is a granular fertilizer that is substantially dehydrated and a substantial portion of the nutrients having low solubility and slow release rates. This reduces or eliminates the loss of plant nutrients to water runoff effects. The novel process results in a product that is a low-odor, enhanced fertilizer useful for the processing and utilization of sewage sludge for agricultural and other purposes.

### CROSS-REFERENCE TO RELATED APPLICATIONS

This application claims benefit of U.S. application Ser. No. 16/175,536, filed Oct. 30, 2018, incorporated herein by reference in its entirety.

### BACKGROUND

Sewage treatment is an integral part of modern society. It is crucial that sewage be treated both correctly and efficiently in order to 1) eliminate contaminants from the sewage prior to it being placed in the environment and 2) reduce and control the volume of sewage, particularly in dense urban environments. Physical, chemical, and biological processes are used to treat the sewage, removing contaminants and producing treated effluent (wastewater) that can be released back into the environment. A byproduct of the sewage treatment process is a slurry referred to as sewage sludge.

While the sewage has been treated and the wastewater is released to the environment, the sludge remains to be disposed of in some manner. Prior to safely returning the sludge to the environment, further treatment is required which may include anaerobic digestion, aerobic digestion, composting, and/or incineration. Dewatering sludge may also be achieved, with the remaining product being incinerated or transported offsite for disposal. Modern environmental and agricultural concerns, however, make it desirable to recover plant nutrients that are present in the sludge so that the nutrients can be recycled rather than discarded and nutrients recovered from other processes. As a fertilizer, it is even more desirable to reuse the sludge in a manner that efficiently or more completely delivers bio-available nutrients. This reduces the need for artificial fertilizer, essentially recycling essential plant nutrients such as nitrogen and phosphorous, in particular, that also release more efficiently. And, as noted above, repurposing sewage sludge as fertilizer helps alleviate the increasing problem of sewage disposal.

In the United States, how sewage is handled is subject to strict controls and regulations, however. The treatment and use of sewage sludge is regulated by the U.S. Federal Government. In particular, The United States Code of Federal Regulations, 40 CFR Part 503 (titled the “Standards for the Use or Disposal of Sewage Sludge”), establishes general requirements and standards, including for pollutant limits, management practices, and operational standards that apply to the final use or disposal of sewage sludge generated during the treatment of domestic sewage. Standards are included for sewage sludge applied to the land, placed on a surface disposal site, or fired in a sewage sludge incinerator. Also included are pathogen and alternative vector attraction reduction requirements for sewage sludge applied to the land or placed on a surface disposal site.

The standards include monitoring and recordkeeping requirements related to the application of sewage sludge to the land, sludge placed on a surface disposal site, or sludge that is fired in a sewage sludge incinerator. Also included are reporting requirements for Class I sludge management facilities, publicly owned treatment works (POTWs) with a design flow rate equal to or greater than one million gallons per day, and POTWs that serve 10,000 people or more.

The regulations noted herein apply to any preparation of sewage sludge, application of sewage sludge to land, the burning of sewage sludge in a sewage sludge incinerator, the owner/operator of a surface disposal site, as well as the exit gas from a sewage sludge incinerator stack. Strict control, therefore, is required for the treatment and use of sewage sludge and any process which utilizes sewage sludge must comply with all of the complex requirements. However, as noted above, there are significant gains to be had by re-purposing sewage sludge for agricultural purposes and other uses. To that end, new and novel means of treating sewage sludge so that it may be recycled and utilized in agriculture and other uses are needed in the art. As an example, in the U.S., the American Association of Plant Food Control Officials (AAPFCO) specifies a guideline for a fertilizer without restrictions applicable to land application, such as the resultant THP product from this novel process.

Currently, a principal means of treating sewage is to subject it to processes to reduce the water content as well as to make the sewage drier and more manageable. Commonly, centrifuges and belt filter presses (BFPs) are used to produce wet cake sludge. More modern treatment methods include thermal hydrolysis process (THPs), which is the pre-treatment of sludge combined with anaerobic digestion. Of the THPs, a currently preferred method is referred to as the “Cambi process.” Cambi's patented THP process (U.S. Pat. No. 5,888,307) operates to dissolve and disintegrate sludge using pressure and temperature. In the process, biological or mixed sludge is pre-dewatered and introduced into a reactor where the direct application of saturated steam hydrolyzes and changes its internal structure, reducing sludge viscosity and increasing its biodegradability.

Although the Cambi Process is discussed herein, it is to be understood to be representative of the group of THP processes currently used in the industry, and the group of THPs are referred to herein as the “THP.” Prior art teaches methods of treatment that are not optimized for the application of nutrients directly to crops and other plants. U.S. Pat. No. 3,942,970 to O'Donnell entitled, “Process for Treating Sewage Sludge and Fertilizer Products Thereof” teaches an apparatus and process of treating sludge that results in a granular product. The O'Donnell invention, however, utilizes sludge products having broad compositional fractions of organic matter, and requires the use of urea and formaldehyde to form a resin (N-methylol-urea) in the reaction process, then condensing at a pH of 3 to 5.

U.S. Pat. No. 5,240,490 to Moore, entitled, “Non-Destructive Recovery of Natural Nitrogen Products” teaches “A continuous process for the non-destructive recovery of natural nitrogenous materials as highly available particulate agricultural nutrients, employing natural materials such as poultry waste, waste water treatment sludge, alfalfa meal, hatchery waste, feathermeal, corn gluten meal and bloodmeal in a fluid bed reactor granulator where basic natural materials are acidified to pHs of 3.0 to 6.5 and formed into hardened particulates during a retention time between 4 and 20 minutes at a temperature between 70° and 120° C. and discharged free of caramelization before nitrogen losses from decomposition amounts to 0.5 percent of the natural nitrogenous materials.”

The O'Donnell and Moore invention, however, were not designed to treat Thermal Hydrolysis Process (THP) products and, as noted, current processing often utilizes the Cambi or other Thermal Hydrolysis Processes. Further, current treatment regimens utilize large amounts of free formaldehyde products like urea-formaldehyde concentrates and release formaldehyde during the process. And under current industrial plant regulations, there are strict limitations for free formaldehyde use in how sewage sludge may be treated and processed on-site, which limits the ability to utilize the O'Donnell and Moore inventions.

THP also results in a shortened hydraulic retention time. THP increases the production of biogas in digestion, reduces the volume needed for digestion, increases the dryness of the final dewatering of digested sludge, eliminates odors, and provides pasteurized final sludge. The process removes the fats contained within sewage, but leaves the proteins intact.

However, the products of THP are not optimally usable without post-THP treatment. In particular, THP results in a product referred to as Class A “sludge cake” that remains approximately 70% water (30% solids), and the THP sludge cake has not been demonstrated to successfully granulate by itself. It cannot be granulated or dried because the fats have been removed. And no traditional biosolids granulation methods have been demonstrated to successfully granulate THP sludge cake.

The regulatory and marketplace environment has significantly impacted the fertilizer and related agricultural field. A large amount of attention is focused on recapturing the nutrients lost through sewage collection and treatment, in part to reduce or eliminate the discharge of sewage, even treated sewage, into the environment. In addition, regulatory, political, and environmental pressures have directed the fertilizer market towards more sustainable use of fertilizer and more efficient use of nutrients. Agricultural runoff from nutrients such as nitrogen, phosphorus, and potassium has direct impacts on water resources and the health of bodies of water such as rivers, estuaries, and oceans. One way to accomplish the goal of reducing negative environmental impacts while increasing the efficiency with which nutrients are delivered in agricultural contexts has led to the desire for enhanced efficiency fertilizers. Ideally, enhanced efficiency fertilizers will allow delivery of most, if not, all of the nutrients in fertilizer into the soil and target plants. Avoiding water-soluble nutrients in fertilizer applied to plants is one way of addressing both the environmental and efficiency concerns.

What is needed, therefore, is a method for processing sewage sludge from existing processes in a manner that renders it useful for agricultural purposes. It is also desirable to process sewage sludge in a manner that is economically efficient and also provides a final product that has increased or enhanced efficiency properties.

### SUMMARY

Disclosed herein is a method of treating sewage sludge, the process comprising: combining sewage sludge with a resin, wherein the resin comprises essentially no free formaldehyde; and mixing the sewage sludge and resin mixture to produce a granular product. The Sewage Sludge can have undergone post-treatment processing, such as the Thermal Hydrolysis Process (THP). Also disclosed is a granular product resulting from this method. This product can be low-odor and high in nitrogen.

Also disclosed is a method of producing a fertilizer, the method comprising the steps of: combining sewage sludge with a resin, wherein the resin comprises no free formaldehyde; and mixing the sewage sludge and resin mixture to produce a granular product; and processing the granular product into a form useable as fertilizer. The sewage sludge can undergo a Thermal Hydrolysis Process (THP) before being subjected to the resin mixture.

### DETAILED DESCRIPTION OF THE PRESENT INVENTION

The compositions, methods, and articles described herein can be understood more readily by reference to the following detailed description. It is also to be understood that the terminology used herein is for the purpose of describing particular aspects only and is not intended to be limiting.

It must be noted that, as used in the specification and the appended claims, the singular forms “a,” “an,” and “the” include plural referents unless the context clearly dictates otherwise.

“Optional” or “optionally” means that the subsequently described event or circumstance can or cannot occur and that the description includes instances where the event or circumstance occurs and instances where it does not.

As used herein, the term “about” is used to provide flexibility to a numerical range endpoint by providing that a given value may be “a little above” or “a little below” the endpoint without affecting the desired result.

“Urea formaldehyde” polymers are synthesized from urea and formaldehyde in the presence of a mild base and can be of varying lengths. In agriculture, urea formaldehyde polymers represent a source of slow-release nitrogen.

By “enhanced efficiency fertilizer” (EEF) is meant fertilizer products with characteristics that allow increased plant uptake and reduce the potential of nutrient losses to the environment (i.e. gaseous losses, leaching or runoff) when compared to an appropriate reference product. (AAPFCO, Official 2009).

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an illustration, a numerical range of “about 1 to about 5” should be interpreted to include not only the explicitly recited values of about 1 to about 5, but also to include individual values and sub-ranges within the indicated range. Thus, included in this numerical range are individual values such as 2, 3, and 4, the sub-ranges such as from 1-3, from 2-4, from 3-5, etc., as well as 1, 2, 3, 4, and 5, individually. The same principle applies to ranges reciting only one numerical value as a minimum or a maximum. Furthermore, such an interpretation should apply regardless of the breadth of the range or the characteristics being described.

The current invention is directed to a new fertilizer product that is a granular reaction product of condensed urea-formaldehyde polymer combined with dewatered sewage sludge cake. The product of a Thermal Hydrolysis Treatment of sewage sludge is further processed by utilizing urea-formaldehyde and sulfuric acid (H2SO4), resulting in an economical and fertilizer-ready product. In the present invention, the process operates by creating a granular fertilizer product from sludge cake by reducing the particle size or form and removing moisture content of the sludge cake, reacting the N-methylol-urea solution with the sludge cake at an acidic pH while agitating the sludge particles to provide a granular-reaction product, and drying the product to provide a granular, high-nitrogen, low odor fertilizer. By “high nitrogen” is meant that the percent by weight of nitrogen in the final product is greater than 5%, 6%, 7%, 10%, 15%, 20%, 21%, 22%, 23%, 24%, 25%, or any amount between or above.

In achieving the granular end-product that is a fertilizer, the current process includes: utilizing sewer sludge, such as that obtained from the THP process; using a urea-formaldehyde resin with low or no free formaldehyde; utilizing a sulfuric acid mixture; and utilizing a mixer to process the sludge and resin mix. By “low or no free formaldehyde” is meant a resin with less than 0.2% free formaldehyde.

In a preferred embodiment, a resin with low to no free formaldehyde is utilized. The current invention may be used either on- or off-site, although the preferred method is to utilize the method on site at the primary sewage treatment facility. The end product of the present invention meets and/or exceeds the U.S. Code of Federal Regulations § 503 Regulations for Class A sewage sludge, and contains no harmful biological organisms such as E. coli, and is derived by a combined approach (with the doubling of THP and rotary dryer methods).

Laboratory Scale Test

Laboratory scale testing was undertaken to determine proof of concept for granulating THP sludge cake with urea-formaldehyde (UF) resin. These tests comprised granulating mixed fertilizer formulations containing THP sludge cake with typical chemical fertilizer ingredients such as urea, ammonium sulfate, diammonium phosphate and sulfate of potash. Those ingredients were combined with a UF resin and sulfuric acid, the sulfuric acid being used to condense or polymerize the UF resin. Other combinations were made using only UF resin and THP sludge cake.

High quality granular products were made of both mixed fertilizer formulas and THP sludge cake, with the result that unfortified biosolids THP sludge cake product granulated with UF resin was chosen as the most commercially viable and efficient product to manufacture utilizing this process.

Pilot Test.

A larger pilot scale test was undertaken to demonstrate the efficacy of the process. The pilot scale test utilized a rotary dryer and a screening system to create a granular commercial fertilizer with the above characteristics sized for the turf and agriculture markets.

1. Raw Materials.

The raw materials utilized for the Pilot Test are:

a. THP Biosolids Wet Cake (THP cake).

THP biosolids wet cake was obtained from a belt filter press at a sewage processing facility, the cake containing approximately 32% solids biosolids. The cake was placed in containers for transport. The cake was maintained in climate-controlled conditions until the Pilot Test runs approximately 48 hours after the material was obtained from the sewage processing facility.

b. Recycle Material.

The present process requires dried recycle material. In order to simulate a dried recycle material as found in a standard sewage treatment process, a material from NEFCO (New England Fertilizer Company) was utilized. In particular, a 5-4-0 (5.0% Nitrogen, 4.0% Phosphorous, and 0.0% Potassium) biosolids material-was chosen as a representative recycle granular material.

c. Urea-Formaldehyde Resin.

For the Pilot Test, a Georgia Pacific (“GP”) urea-formaldehyde resin (GP 253A34 Composite Board Adhesive) was utilized. The estimated analysis from GP was 42% Urea and 58% Formaldehyde (˜20% Nitrogen).

c. Sulfuric Acid (H₂SO₄). 93% concentrated sulfuric acid was used to polymerize the UF resin.

2. Process Equipment Used.

a. High Intensity Mixer.

In order to mix the materials, a 130-liter batch high-intensity mixer was used in the Pilot Test. It is noted that any type of mixer can be used, such as an Eirich mixer or a Littleford Mixer. The Littleford mixer is comprised of a cylindrical body with a main drive shaft running horizontally through the center. Extending from the main shaft are four plows which fluidize the materials around the inside perimeter of the cylindrical mixer body. There is one chopper (similar to a blender blade) penetrating the mixer in the back lower center of the body. The chopper provides mechanical means to break down larger ‘lumps’ and create a more uniformly sized finished product and was used for all runs.

b. Dryer.

A single pass, rotary drum, natural gas fired dryer was utilized to dry the product after mixing. The dryer used for the Pilot Test was approximately 30 feet long and 3.5 feet in diameter. There were no lifting flights on the initial two feet of the drum, and the remainder of the drum has 3 to 4 inches flights to the discharge end of the unit.

c. Screener.

In order to separate the final product by size, the product output of the dryer was run through a round vibratory Sweco Screener. Different size granular product was achieved by utilizing three separate mesh sizes: overs (<6 mesh), on-size (6 to 14 mesh), and fines (>14 mesh).

3. Method.

In accordance with pre-planned procedures, the ingredients were measured by weight, and weighed separately prior to each batch run. Solid materials were added to the mixer through the access door and liquids were poured in through the top vent stack. Each batch was formulated to be 83 pounds to achieve the optimum fill level (up to the main shaft) in the mixer. The total mixing time for the batches was limited to one to two minutes. Motor amperages were monitored for the main shaft. Chopper amperage did not vary once the motor was started. Once a batch was complete, it was discharged from the bottom of the mixer through a dump door into a tub which was taken directly to the dryer feed belt.

For drying, the product was fed by hand onto a cleated inclined belt at a rate of approximately 20 pounds per minute into the dryer. The dryer inlet air temperature was maintained at 210° and the burner temperature was maintained at 700° * to 800°. Exit temperature of the product was approximately 205° (all temperatures are in Fahrenheit).

A yield of about 52% of on size product (the preferred size product) was achieved; the remaining 48% was utilized as recycle in subsequent test runs.

4. Test Runs.

a. Test Run 1.

Test Run 1 utilized a formulation from the successful THP cake and resin tests at small (laboratory) scale. No supplemental fertilizer ingredients were included. THP cake and recycle were added to the mixer and the main shaft (plows) and chopper were run for approximately 30-35 seconds to achieve a homogeneous mix. On inspection, the mixture was a wet, but loose granular consistency.

The main shaft and chopper were restarted and the resin was poured in over a 30 second period. Main shaft amps increased and the mixer vibration indicated that the biosolids mixture was agglomerating into a mass. This was verified visually. The mixer was restarted and the acid added over a 30 second period. The mixer was stopped and the charge door opened to inspect the product. The material was in a mass but granulation had been achieved. There had been obvious heat of reaction following the acid addition. The material sat in the mixer for approximately 2-3 minutes then the main shaft was started and the material was discharged through the dump door into the tub. Material in the tub had become less agglomerated and more free-flowing, ‘wet’ granules.

In all runs the reacted/condensed final product was not overly sticky at any point following the acid addition, and released into a freer flowing material as it cooled, likely due in part to the resin continuing to polymerize/condense and the product losing both moisture and heat over time. This could be referred to as ‘curing’. The product handled well out of the discharge tub and flowed well off the belt to drier.

Dried finished product:

pH=4

Product density=38.15 pounds/cubic foot

b. Test Run 2.

Test Run 2 was conducted in the same manner as Test Run 1, with the amount (weight) of resin reduced by 50%. The run parameters and product characteristics were similar however the overall granule size appeared larger out of the mixer. This is likely a function of the reduced resin content. Typically, given similar moisture contents, formulations with higher amounts of resin will break down into smaller granules, being more ‘brittle’ and less friable.

Dried finished product:

pH=4

Product density=40.15 pounds/cubic foot

c. Test Run 3.

Test Run 3 was initially conducted in the same manner as Test Runs 1 and 2, but with the weight of resin reduced to 25% of original formula. After addition of liquids the material in the mixer was primarily a homogenous mass with very little granule formation and that did not appear that it would run through the dryer successfully. The material was set aside. The failure to granulate is likely a result of using introducing less resin amount weight that is lower than the lower limit of resin necessary to achieve the required granulation. for a commercially viable finished product.

d. Test Run 4.

Test Run 4 was conducted in the same manner as before, with the weight of resin added equal to 37% of Run 1. The resulting material in the mixer was minimally acceptable, with the material substantially agglomerated (in a wet mass). , while appearing to have retained unwanted moisture. The pH was tested and found to be close to 5, while the target pH is 3.4 to 4.0. An additional 0.5 lbs. of acid was added to reduce the pH and further polymerize the resin. After adding the additional acid, the material broke and became more granulated, with granule size closer to the desired target size. The product also appeared to contain less moisture and the resin more completely reacted. The pH of the product was approximately 3.5, within the target range.

Based upon the results from adding the additional acid to the Test Run, the mixer was charged with ungranulated material from Test Run 3 as well as additional acid. The material was mixed and chopped for approximately one minute. The resulting product had broken down into mostly finer, undersized, granulated product outside at the low end of the desirable size range. The results showed that the lowering of the pH and adding mixing and chopping time resulted in a more complete polymerization cure of the resin. The product had also cooled more, and retained less moisture.

Dried Finished Product:

pH˜4.

Product density=40.25 pounds/cubic foot

e. Test Run 5.

Test Run 5 was conducted in the same manner as Test Run 3, with the weight of resin added 25% to 37% of Run 1, with an additional 0.5 pounds of acid added right after the introduction of the resin to the mixer. The resulting product was an agglomerated mass, however that had not granulated. It was observed that if the mixer discharged directly into the dryer, it would likely produce an acceptable granular material. Under the testing configuration, however (with the pilot plant operated in a “batch mode”) the agglomerated product in the mixer was unlikely to successfully transfer up the belt and into the dryer. As a result of this and previous Tests, it was observed that the optimum UF resin formulation amount for this specific process is approximately 37% of the resin used in Test Run 1.

f. Test Run 6.

Test Run 6 was formulated using 37% of the resin used in Test Run 1. The base material for this Test Run used recycle material from Test Runs 1 and 2 (mostly fines and some overs). Test Run 6 was designed to mimic the likely conditions for a liquid addition during a continuous process rather than a batch process as in Test Runs 1-5. This was done to determine the effect on the quality of the final product. To that end, the resin and acid was added in close conjunction with each other; the resin pour was started approximately 10 seconds before starting the addition of acid. The resulting product was very fine, and so was set aside. The result demonstrated that agglomeration and granulation is affected by the timing of the resin and acid addition. In order to control the timing of liquid additions effect in a continuous mixer-reactor, during a continuous process (in actual operation), placement of liquid injection lances in the mixer-reactor would need to be optimized. Little experimentation would be required to optimize the injection lance positions.

g. Test Run 6.5 (5&6).

Given that neither Test Run 5 or Test Run 6 resulted in a desirable product, and that Run 5 was agglomerated (i.e., substantially unprocessed) while Run 6 was substantially undersized primarily fines (i.e., substantially over processed), the products of Test Runs 5 and 6 were blended together in the mixer to determine if an acceptable, granulated product could be achieved with subsequent processing. Initially, half of the product from each batch was added to the mixer, and the main shaft and chopper run for approximately 30 seconds. The resulting product showed that the agglomerated material from Test Run 5 had broken down, but the combined mixture was still principally undersized granules. Water was added and further mixing and chopping resulting in generally uniform, on-size granules. The product was run through the dryer twice to reach acceptable dryness. Regranulation with the addition of water results in an acceptable product, with few fines (small) granules.

h. Test Run 7.

For Test Run 7, the 37% resin formula was reproduced, again adding approximately 25-30% of the resin before starting the acid addition. As before, the material broke down extensively and produced significant fines. The material was placed back in the mixer, and water was added (as in Test Run 6.5) to produce on-size granules. As with Test Run 6.5, the addition of water resulted in acceptable on-size product production. As in Test Run 6.5, the material was run through the dryer twice to reach the appropriate moisture level. Of note was that the THP biosolids cake used in Test Run 7 was 35.5% solids DM as opposed to the 31% assumed in the formula from the plant, which accounts for the requirement of additional water to achieve desired granulation.

Results and Analysis.

a. Overview:

The final pH of the mix out of the mixer ranged between 3-5 in all batches.

The THP cake does not appear to become thixotropic like standard biosolids

Granulation is controlled by balancing several factors:
Quantity of UF Resin
THP cake will not granulate without UF resin
Granulation size will increase as UF percentage increases to an optimum level given adequate polymerization/condensation of the UF resin
Granulation size will then decrease as UF percentage increases beyond the optimum level.
Moisture content of the final product, which is directly as a result of:
   % moisture in the THP Cake
   % of recycle used in the formulation
   Regranulation of fine material into stable on-size granules is possible
   Reaction time of the resin and acid combination
   Timing of the resin and acid additions
   Length of time the material has to ‘cure’ following acid addition
      Material in an agglomerated mass out of the batch mixer will break down after a resting period as the product cools and polymerizes
pH of the final mixture
Adjustments to screen size (i.e., increasing from 14 to 16) can provide more acceptable on-size product.
   b. Detailed Results.

While useful material was obtained in each Test Run, due to the commercial viability of the products of Test Run 4 and Test Run 5, material from those Test Runs was chosen for detailed chemical analysis.

The material in each was sent for analysis of the following nutrients: Nitrogen (Total Nitrogen, Organic Nitrogen, Ammonium Nitrogen, and Nitrate Nitrogen)

Major and Secondary Nutrients (Phosphorous, Phosphorous as P205, Potassium,

Potassium as K20, Sulfur, Calcium, Magnesium, and Sodium)

Micronutrients (Zinc, Iron, Manganese, Copper, and Boron)

Other Properties (Moisture, Total Solids, Organic Matter, Ash, C:N Ratio; Total Carbon, Chloride, and pH).

The results for Test Run 4 are as follows in Table 1:

TABLE 1
TEST RUN 4 ANALYSIS

| Nitrogen | | | | |
|---|---|---|---|---|
| Total Nitrogen | % | 10.48 | 13.52 | 209.6 |
| Organic Nitrogen | % | 10.29 | 13.28 | 205.9 |
| Ammonium Nitrogen | % | 0.187 | 0.241 | 3.7 |
| Nitrate Nitrogen | % | <0.01 | — | — |
| Major and Secondary Nutrients | | | | |
| Phosphorus | % | 1.50 | 1.94 | 30.0 |
| Phosphorus as P2O5 | % | 3.44 | 4.44 | 68.8 |
| Potassium | % | 0.12 | 0.15 | 2.4 |
| Potassium as K2O | % | 0.14 | 0.18 | 2.8 |
| Sulfur | % | 2.05 | 2.65 | 41.0 |
| Calcium | % | 1.23 | 1.59 | 24.6 |
| Magnesium | % | 0.22 | 0.28 | 4.4 |
| Sodium | % | 0.060 | 0.077 | 1.2 |
| Micronutrients | | | | |
| Zinc | ppm | 612 | 790 | 1.2 |
| Iron | ppm | 47000 | 60645 | 94.0 |
| Manganese | ppm | 670 | 865 | 1.3 |
| Copper | ppm | 258 | 333 | 0.5 |
| Boron | ppm | <100 | — | — |

OTHER PROPERTIES

| | | | | |
|---|---|---|---|---|
| Moisture | % | 22.50 | | |
| Total Solids | % | 77.50 | | 1550.0 |
| Organic Matter | % | 53.90 | 69.55 | 1078.0 |
| Ash | % | 21.40 | 27.61 | 428.0 |
| C:N Ratio | | 2:1 | | |
| Total Carbon | % | 23.06 | 29.75 | |
| Chloride | % | 0.03 | 0.04 | |
| pH | | 2.7 | | |

The results for Test Run 5 are as follows in Table 2:

TABLE 2
TEST RUN 5 ANALYSIS

| | | |
|---|---|---|
| Analysis | Analysis | Total content, |
| (as | (dry | lbs per ton |
| rec'd) | weight) | (as rec'd) |

NUTRIENTS

| | | | | |
|---|---|---|---|---|
| Nitrogen | | | | |
| Total Nitrogen % | | 9.30 | 14.05 | 186 |
| Organic Nitrogen % | | 9.08 | 13.72 | 181.7 |
| Ammonium Nitrogen % | | 0.216 | 0.326 | 4.3 |
| Nitrate Nitrogen % | | <0.01 | — | — |
| Major and Secondary | | 1.18 | 1.78 | 23.6 |
| Nutrients Phosphorus % | | | | |
| Phosphorus as P2O5 % | | 2.70 | 4.08 | 54.0 |
| Potassium % | | 0.09 | 0.14 | 1.8 |
| Potassium as K2O % | | 0.11 | 0.17 | 2.2 |
| Sulfur % | | 2.41 | 3.64 | 48.2 |
| Calcium % | | 1.10 | 1.66 | 22.0 |
| Magnesium % | | 0.22 | 0.33 | 4.4 |
| Sodium % | | 0.050 | 0.076 | 1.0 |
| Micronutrients | | | | |
| Zinc | ppm | 512 | 773 | 1.0 |
| Iron | ppm | 35600 | 53776 | 71.2 |
| Manganese | ppm | 506 | 764 | 1.0 |
| Copper | ppm | 216 | 326 | 0.4 |
| Boron | ppm | <100 | — | — |

OTHER PROPERTIES

| | | | |
|---|---|---|---|
| Moisture % | 33.80 | | |
| Total Solids % | 66.20 | | 1324.0 |
| Organic Matter % | 45.20 | 68.28 | 904.0 |
| Ash % | 19.20 | 29.00 | 384.0 |
| C:N Ratio | 2:1 | | |
| Total Carbon % | 19.38 | 29.27 | |
| Chloride % | 0.03 | 0.05 | |
| pH | 3.1 | | |

The results of dry matter testing in the finished product from the Test Runs is as follows in Table 3:

TABLE 3
DRY MATTER LOG - TRIALS Oct. 3, 2018

| | | SAMPLE | | | | DRY |
|---|---|---|---|---|---|---|
| | DATE | ID | TARE | START | FINISH | MATTER |
| A | Oct. 3, | inbound | 2.2102 | 11.3009 | 5.4420 | 35.55% |
| | 2018 | sludge | | | | |
| B | Oct. 3, | run 1, post | 2.2189 | 9.3193 | 6.9212 | 66.23% |
| | 2018 | Littleford | | | | |
| C | Oct. 3, | run 2, post | 2.2061 | 7.6263 | 5.7677 | 65.71% |
| | 2018 | Littleford | | | | |
| D | Oct. 3, | run 1, | 2.2040 | 7.4308 | 6.9326 | 90.47% |
| | 2018 | post drum | | | | |
| E | Oct. 3, | run 2 | 2.2259 | 9.8292 | 9.1766 | 91.42% |
| | 2018 | post drum | | | | |
| F | Oct. 3, | run 4, post | 2.1944 | 7.2532 | 5.5983 | 67.29% |
| | 2018 | Littleford | | | | |
| G | Oct. 3, | run 4, | 2.2120 | 7.9878 | 7.4544 | 90.76% |
| | 2018 | post drum | | | | |
| H | Oct. 3, | runs 5 & 6, post | 2.2099 | 9.8858 | 6.8342 | 60.24% |
| | 2018 | Littleford | | | | |
| I | Oct. 3, | runs 5 & 6, post | 2.2001 | 7.2901 | 6.9081 | 92.50% |
| | 2018 | | | | | |
| J | Oct. 3, | run 4, finished | 2.2138 | 7.3083 | 6.9136 | 92.25% |
| | 2018 | product | | | | |
| K | Oct. 3, | run 5 & 6, | 2.2182 | 7.2804 | 6.8836 | 92.16% |
| | 2018 | onsize | | | | |
| L | Oct. 3, | run 5 & 6, | 2.2270 | 7.8426 | 6.9999 | 84.99% |
| | 2018 | oversize | | | | |
| M | Oct. 3, | run 7, post | 2.2179 | 8.5402 | 6.2455 | 63.70% |
| | 2018 | Littleford | | | | |
| N | Oct. 3, | run 7, | 2.1863 | 8.1619 | 7.7091 | 92.42% |
| | 2018 | post drum | | | | |
| O | Oct. 3, | Finished product - | 2.1788 | 7.3009 | 6.9219 | 92.59% |
| | 2018 | dried 2x | | | | |

As seen above in Table 2, the method disclosed herein results in significant reductions in the water content of the final product. This reduction in water content (30-36% to 3-5% in a commercial setting) provides significant advantages. First, it reduces product weight significantly, thereby reducing the transportation and handling costs for the product. Second, in the process of removing water and sludge cake to granular fertilizer value is added by the easier use when handling in either its application or in its blending since the granular form and dryness allow it to be mixed with other fertilizer materials the fertilizer industry commonly uses. Third, through formation of the dry fertilizer granule by condensing the UF resin into slow releasing methylene urea compounds, all nutrients in the granule will release more slowly in the soil, which reduces or eliminates the loss of those nutrients to runoff and the resulting contamination of water. Fourth, by raising the nitrogen content of the THP cake through formation of the fertilizer granules, the amount of soluble nutrients from the THP cake applied will be reduced due to lower application rates needed to meet the soil deficiency, crop nitrogen requirement.

Additional advantages are, by purchasing a low or no free formaldehyde resin, environmental permitting issues associated with the process are substantially minimized. And, converting the THP Class A sewage sludge to a registered enhanced efficiency fertilizer product (AAPFCO) removes all Department of Environmental Quality state regulations associated with the use in land application of biosolids.

The invention has been described herein in sufficient detail that one of skill in the art can reproduce the invention. The invention as described herein, however, is not intended to be limited in scope, and it will be understood that various embodiments of the invention fall within the scope of the invention herein and are not excluded as a result of modifications that remain within the spirit and scope of this disclosure.

What is claimed is:

1. A method of treating sewage sludge, the process comprising:
a. Combining sewage sludge cake with a resin, wherein the resin comprises essentially no free formaldehyde; and
b. Mixing the sewage sludge cake and resin mixture to produce a granular product.

2. The method of claim 1, wherein the sewage sludge cake has undergone a Thermal Hydrolysis Process (THP).

3. The method of claim 1, wherein the pH of the sewage sludge cake and resin mixture is maintained between about 3 to 6 during mixing.

4. The method of claim 1, wherein the sewage sludge cake has been sterilized before it is combined with the resin.

5. The method of claim 1, wherein the resin comprises condensed urea-formaldehyde.

6. The method of claim 1, wherein a mixer is used to mix the resin and the sewage sludge cake.

7. The method of claim 1, wherein after mixing, the granular product is dried.

8. The granular product resulting from the method of claim 1.

9. The granular product of claim 8, wherein the product is high in nitrogen.

10. A method of producing a fertilizer, the method comprising the steps of:
a) Combining sewage sludge with a resin, wherein the resin comprises no free formaldehyde; and
b) Mixing the sewage sludge and resin mixture with acid to produce a granular product;
c) Processing the granular product into a form useable as fertilizer.

11. The method of claim 10, wherein the sewage sludge has undergone a Thermal Hydrolysis Process (THP).

12. The method of claim 10, wherein the pH of the granular product is between about 3 to 6 during mixing.

13. The method of claim 10, wherein the resin comprises condensed urea-formaldehyde.

14. The method of claim 10, wherein the resin is polymerized by exposing it to sulfuric acid.

15. The method of claim 10, wherein a mixer is used to mix the resin and the dried sewage sludge and acid.

16. The method of claim 10, wherein after mixing, the mixture is dried.

17. A fertilizer made by the method of claim 10.
